(19) United States
(12) Patent Application Publication
(10) Pub. No.: US 2006/0260479 A1
(43) Pub. Date: Nov. 23, 2006

(54) Needle printing device

(76) Inventor: Juergen Huebschen, Wadern (DE)

Correspondence Address: PLEVY & HOWARD, P.C., P.O. BOX 226, FORT WASHINGTON, PA, 19034, US

(21) Appl. No.: 11/431,954

(22) Filed: May 11, 2006

(30) Foreign Application Priority Data
May 17, 2005 (DE) DE 102005023379.1

(51) Int. Cl. B44B 5/00; B41N 1/00

(52) U.S. Cl. 101/3.1; 101/453

(57) ABSTRACT

A needle printing device for embossing characters in a metal body includes a print head having at least one axially adjustable embossing needle as well as a holding device for holding the metal body, wherein the print head and the holding device are adjustable in relation to one another. To reduce the emission of noise during operation of the needle printing device, the holding device has a sound-absorbing support whose outside facing the metal body is adapted as a negative impression to a bottom side of the metal body facing the sound-absorbing support.

### FIELD OF THE INVENTION

The present invention relates to a needle printing device for embossing characters in a metal body.

### BACKGROUND OF THE INVENTION

In a number of applications, a metal body must be provided with a permanent inscription, which is expediently accomplished by embossing the metal with the corresponding characters. For example, in automobile manufacturing, a number of individual metal bodies must be provided with parts numbers, manufacturing dates, brand names or the like. These are mass production applications, so an automatically functioning printing device is needed to print the individual metal bodies. So-called needle printers are known for printing paper in general; with these printers, a print head has a plurality of needles that are individually adjustable axially.

A needle printing device can be equipped with a print head having at least one axially adjustable embossing needle which embosses the desired characters into a top side of the metal body facing the print head in the printing operation. To print the desired inscription, it may be necessary to adjust the print head in relation to the metal body.

To be able to perform embossing of metal bodies in this way, relatively high embossing forces must be applied to the respective embossing needle. In addition, the respective embossing needle must operate at a high frequency to be able to produce complex inscriptions on the respective metal body even as part of mass production. Under these conditions, the printing operation is usually associated with a relatively high noise level. If the metal body is sheet metal, the noise production in the printing operation is magnified by the sound-reflecting effect of the sheet metal. People who work in the vicinity of such a needle printing device are exposed to extremely high noise levels accordingly. A needle printing device characterized by reduced noise level is desirable.

### SUMMARY OF THE INVENTION

The present invention is based on the general idea of providing a holding device that serves to hold the metal body in the printing operation with a sound-absorbing support for the holding device; which is designed as the negative impression of the bottom side of the metal body facing away from the print head. This yields a support that has a sound-absorbing effect over a large-area, such as over the full area on the bottom side of the metal body. Vibration excitation and sound emission by the metal body in the printing operation can be reduced greatly in this way. The pulse waves introduced into the metal body in printing may at least be mostly absorbed in the material of the sound-absorbing support so that this energy is no longer available for emission of sound waves into the environment.

The sound-absorbing support preferably has an essentially constant thickness along its extent along the metal body. This achieves the result that the structure-borne sound waves propagating in the metal body can be absorbed as uniformly as possible by the sound-absorbing support.

In accordance with an aspect of the present invention, a particularly advantageous effect is when the metal body is made of sheet metal because the full-area contact between the sheet metal and the sound-absorbing support is especially capable of intensely absorbing the sound reflected on the sheet metal.

It is self-evident that the features mentioned above and those to be explained below may be used not only in the particular combinations indicated, but also in other combinations, or they may be used alone without going beyond the scope of the present invention.

### BRIEF DESCRIPTION OF THE DRAWINGS

A preferred exemplary embodiment of the present invention is depicted in the drawing and explained in greater detail in the following description.

FIG. 1, which is the only figure, shows a greatly simplified basic diagram, partially cut away, of a needle printing device according to an exemplary embodiment of the present invention.

### DETAILED DESCRIPTION OF THE PREFERRED EMBODIMENT OF THE PRESENT INVENTION

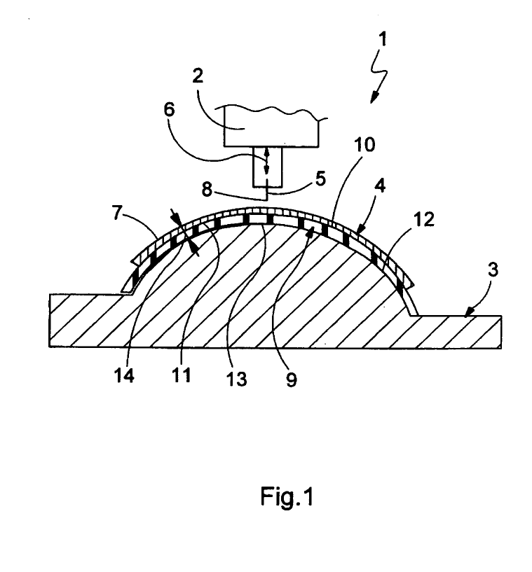

According to FIG. 1, a needle printing device 1 has at least one print head 2 and a holding device 3. The needle printing device 1 is used for embossing characters in a metal body 4. The characters may be characters of any type such as letters, numerals, pictograms, logos, etc.

The print head 2 has at least one embossing needle 5 which is axially adjustable according to a double arrow 6. The holding device 3 is designed so that the metal body 4 can be held tightly enough against it.

For embossing characters into the metal body 4, the respective embossing needle 5 travels at a relatively high rate of speed out of the print head 2, which leads to a corresponding embossing on a top side 7 of the metal body 4 facing the print head 2. This embossing then has a contour complementary to the shape of a needle tip 8. For example, the needle tip 8 may be in the shape of a dot, so that the individual embossing is in the shape of a dot. To create characters, therefore a plurality of such embossings aligned in a row must be produced. To this end, an adjustment device (not shown here) is provided; with the help of this device, print head 2 and holding device 3 can be adjusted in relation to one another. To achieve a relatively high printing speed, the print head 2 operates at a relatively high embossing frequency for the embossing needle 5.

According to an aspect of the invention, the holding device 3 is equipped with a sound-absorbing support 9. This sound-absorbing support 9 has an outside 10 which faces the metal body 4 during the printing operation. In the printing operation, the metal body 4 rests on the sound-absorbing support 9 and/or its outside 10 with the bottom side 11 of the metal body facing away from the print head 2. The outside 10 of the sound-absorbing support 9 is designed as a negative impression to the bottom side 11 of the metal body 4. This automatically results in large-area and/or full-area contact between the metal body 4 and the sound-absorbing support 9.

Furthermore, the holding device 3 is equipped with an abutment contour 12 which faces the metal body 4 during the printing operation. The sound-absorbing support 9 is situated on this abutment contour 12 in such a way that the abutment contour 12 supports an inside 13 of the sound-absorbing support 9 facing away from the print head 12.

According to the preferred embodiment shown here, the inside 13 of the sound-absorbing support 9 is designed as a negative impression in relation to the abutment contour 12 of the holding device 3. Accordingly, here again there is large-area and/or full-area contact between the sound-absorbing support and the abutment contour 12. This yields a particularly intense support of the sound-absorbing support 9 on the abutment contour 12.

In addition, the sound-absorbing support 9 may have a thickness 14 which is essentially constant along the extent of the sound-absorbing support 9 along the metal body 4, which lies on top of it, as shown here. This presupposes that the abutment contour 12 essentially follows the course of the bottom side 11 of the metal 4. In this way, the sound-absorbing effect of the sound-absorbing mat 9 is essentially constant along the extent of the bottom side 11 of the metal body 4. In other words, structure-borne sound waves propagating during the printing operation in the metal body 4 are muffled essentially uniformly along the bottom side 11 of the metal body 4. In other embodiments, the sound-absorbing support 9 may also have a thickness 14 that varies along its extent along the metal body 4.

The sound-absorbing support 9 is preferably made of an elastic sound-absorbing material. For example, the sound-absorbing support 9 may be made of plastic, in particular a rubbery plastic, preferably an elastomer, e.g., Elastosil® or rubber.

In order for the outside 10 of the sound-absorbing support 9 to form the most accurate possible negative impression of the bottom side 11 of the metal body 4, the sound-absorbing support 9 may be manufactured by casting or injecting a suitable sound-absorbing material onto the bottom side 11 of the metal body 4, for example. This procedure is suitable in particular for using the needle printing device 1 as part of a mass production run, when large numbers of identical metal bodies 4 are to be printed. The sound-absorbing support 9 manufactured in this way fits accordingly with all of the same metal bodies 4 within the manufacturing tolerances of said metal bodies 4.

Metal body 4 is preferably sheet metal, as in the present case. This sheet metal (metal body 4) may form a component of a sheet metal part that can be assembled from multiple sheet metal parts. For example, the sheet metal (metal body 4) may be a shell or a bottom of a sheet metal casing and/or a housing-like sheet metal component.

Essentially, however, it is also possible to print more complex metal bodies 4 with the help of the needle printing device 1. Therefore, the metal body 4 may also be a sheet metal part assembled from multiple individual sheet metal parts, for example.

The sheet metal components mentioned above are preferably components of an exhaust system of an internal combustion engine and/or the housing for such components, without restricting the general scope of the invention. Such a component may be, for example, a muffler, a particulate filter, a catalytic converter or a heat transfer medium.

The inventive needle printing device 1 is characterized in that the emission of noise in to the environment which is associated with the printing process is greatly reduced because the structure-borne sound propagating in the metal body can be absorbed at least partially by the sound-absorbing support 9. An intense sound-absorbing effect is achieved here through the large-area and/or full-area contact between the bottom side 11 of the metal body 4 and the outside 10 of the sound-absorbing support 9 and in particular due to the large-area, i.e., full-area contact between the inside 13 of the steamer body 9 and the abutment contour 12 of the holding device 3.

1. A needle printing device for embossing characters in a metal body, comprising:
a print head having at least one axially adjustable embossing needle, and
a holding device for holding the metal body,
wherein the print head and the holding device are adjustable in relation to one another, and
wherein the holding device has a sound-absorbing support whose outside facing the metal body is adapted as a negative impression to the bottom side of the metal body facing the sound-absorbing support.

2. The needle printing device according to claim 1, wherein the holding device has an abutment contour facing the metal body on which the abutment support is supported on its inside facing away from the metal body.

3. The needle printing device according to claim 1, wherein the at least one embossing needle embosses the characters into a top side of the metal body facing away from the sound-absorbing support during the printing operation.

4. The needle printing device according to claim 1, wherein the inside of the sound-absorbing support is a negative impression to the abutment contour.

5. The needle printing device according to claim 1, wherein the sound-absorbing support has an essentially constant thickness along its extent along the metal body.

6. The needle printing device according to claim 1, wherein the sound-absorbing support is made of an elastic sound-absorbing material or a plastic or rubber or a rubbery plastic.

7. The needle printing device according to claim 1, wherein the metal body is sheet metal.

8. The needle printing device according to claim 1, wherein the metal body is part of a sheet metal component that can be assembled from multiple sheet metal parts.

9. The needle printing device according to claim 1, wherein the sheet metal is a shell or a bottom of a sheet metal component in the form of a housing.

10. The needle printing device according to claim 1, wherein the metal body is a sheet metal component that is assembled from multiple sheet metal parts.

11. The needle printing device according to claim 9, wherein the sheet metal component is a component of an exhaust system of an internal combustion engine or a housing for such a component.

12. The needle printing device according to claim 10, wherein the sheet metal component is a component of an exhaust system of an internal combustion engine or a housing for such a component.
